(19) United States
(12) Patent Application Publication
(10) Pub. No.: US 2007/0139394 A1
(43) Pub. Date: Jun. 21, 2007

(54) Flat panel display having touch panel for controlling on screen display thereof

(75) Inventor: Chiu-Huang Weng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,303

(22) Filed: Dec. 20, 2006

(30) Foreign Application Priority Data
Dec. 21, 2005 (CN) 200510121045.5

(51) Int. Cl. G09G 5/00

(52) U.S. Cl. 345/173

(57) ABSTRACT

An exemplary flat panel display (1) includes a display unit (10), a touch panel unit (12), and a host (16). The touch panel unit is configured (i.e., structured and arranged) for detecting contact by a stylus or a user's fingertip, recognizing a position of a point of the contact, and processing the contact as a corresponding instruction in relation to controlling an on screen display of the display unit. The host is electrically connected with the touch panel unit via a connection route (14). The host is configured for receiving position information based on the recognized contact position and converting the information to one or more corresponding control signals for controlling the on screen display of the display unit.

### FIELD OF THE INVENTION

The present invention relates to flat panel displays (FPDs), and more particularly to a flat panel display having a touch panel for controlling an on screen display (OSD) thereof.

### GENERAL BACKGROUND

Flat panel displays are commonly used as display devices for compact electronic apparatuses. Referring to FIG. 5, a typical flat panel display 5 includes a front frame 50, a back cover 52, a display panel 54, a plurality of control buttons 56, and an indicating illuminator 58. The front frame 50 and the back cover 52 cooperatively define a space (not labeled) for accommodating the display panel 54. The front frame 50 further defines a window (not labeled) for allowing viewing of the display panel 54. The control buttons 56 are located at a bottom portion of the front frame 50 for allowing inputting of control commands by, for example, an operator. The indicating illuminator 58 is located at a low right corner of the front frame 50 for indicating an activation state of the flat panel display 5.

In operation, when one of the control buttons 56 is pressed, an input signal is generated and is transmitted to a control circuit board (not shown) of the flat panel display 5. A control signal is correspondingly generated by the control circuit board. The control signal is transmitted to the display panel 54, thereby adjusting an OSD of the display panel 54. That is, the OSD of the display panel 54 can be controlled by the control buttons 56.

However, the control buttons 56 have to occupy a large area of the front frame 50 to avoid accidental pressing of an incorrect control button 56. This results in an overly large area of the flat panel display 5 being used for non-display related purposes. Furthermore, the control buttons 56 of the OSD of the display panel 54 may easily be accidentally pressed by, for example, someone brushing past the display panel 54 in a public place.

What is needed, therefore, is a flat panel display that can overcome the above-described deficiencies.

### SUMMARY

In one preferred embodiment, a flat panel display includes a display unit, a touch panel unit, and a host. The touch panel unit is configured (i.e., structured and arranged) for detecting contact by a stylus or a user's fingertip, recognizing a position of a point of the contact, and processing the contact as a corresponding instruction in relation to controlling an on screen display of the display unit. The host is electrically connected with the touch panel unit via a connection route. The host is configured for receiving position information based on the recognized contact position and converting the information to one or more corresponding control signals for controlling the on screen display of the display unit.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is essentially an isometric view of a flat panel display according to a first embodiment of the present invention.

FIG. 2 is an isometric view of a flat panel display according to a second embodiment of the present invention.

FIG. 3 is an exploded, isometric view of a flat panel display according to a third embodiment of the present invention.

FIG. 4 is an assembled view of the flat panel display of FIG. 3.

FIG. 5 is an isometric view of a conventional flat panel display.

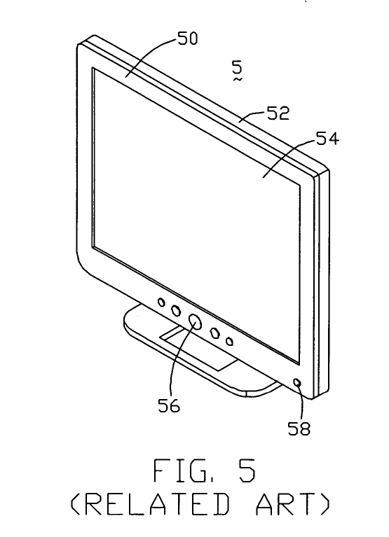

### DETAILED DESCRIPTION OF PREFERRED EMBODIMENTS

Reference will now be made to the drawings to describe the preferred embodiments in detail.

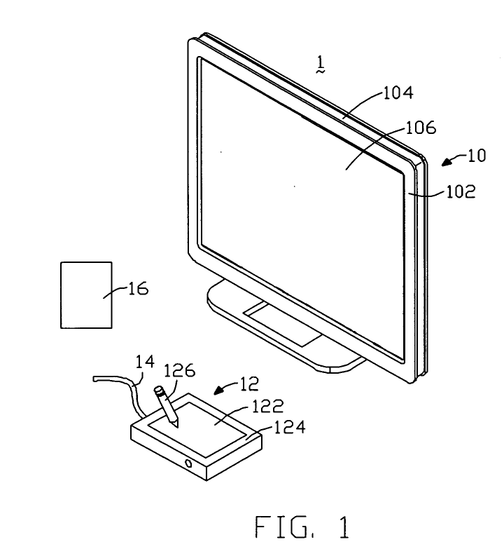

Referring to FIG. 1, a flat panel display 1 according to a first embodiment of the present invention is shown. The flat panel display 1 includes a display unit 10, a touch panel unit 12, a connection wire 14, and a host 16.

The display unit 10 includes a front frame 102, a back cover 104, and a display panel 106. The front frame 102 and the back cover 104 cooperatively define a space (not labeled) for accommodating the display panel 106. The display panel 106 can display a menu which shows display parameters or a state of the display panel 106. Typical menu items include brightness of the display panel 106, contrast of the display panel 106, color balance of the display panel 106, sharpness of the display panel 106, horizontal position of the menu, vertical position of the menu, phase of the display panel 106, a clock of the display panel 106, and power saving mode of the display panel 106. This menu is referred to as the OSD menu of the display panel 106.

The touch panel unit 12 includes a touch panel 122, a frame-shaped shell 124, a power device (not shown), and a stylus pen 126. The touch panel 122 can detect contact by the stylus pen 126. In particular, the touch panel 122 can recognize the position of a point of contact thereon by the stylus pen 126, and process the contact as a corresponding instruction. The stylus pen 126 can be used for conveniently selecting a desired OSD control of the display panel 106. The shell 124 receives and protects the touch panel 122. The power device provides electrical power for the touch panel 122.

One terminal (not labeled) of the connection wire 14 is electrically connected with the touch panel 122, and the other terminal (not labeled) of the connection wire 14 is electrically connected with the host 16. The host 16 electrically connects to the display unit 10. That is, the connection wire 14 acts as a connection route between the touch panel 122 and the host 16. In alternative embodiments, the host 16 can connect to the display unit 10 via a wireless connection, such as a Bluetooth connection, an infrared-ray (IR) connection, a radio-frequency (RF) connection, or another suitable connection.

The OSD of the display panel 106 can be controlled according to the following steps. First, the stylus pen 126 is brought into contact with the touch panel 122 as desired, and a contact position is detected and recognized by the touch panel 122. Second, position information based on the recognized contact position is transmitted from the touch panel 122 to the host 16 via the connection wire 14. Third, a program is run in the host 16 for processing the position information, and the position information is converted to a corresponding control signal for controlling the display panel 106. Finally, the control signal is transmitted to the display panel 106, and the OSD of the display panel 106 is adjusted correspondingly.

The OSD of the display panel 106 can be controlled by the touch panel 122 and the stylus pen 126, and therefore the number of control buttons needed on the display panel 106 can be reduced. This can result in only a small-sized area of the flat panel display 1 being used for non-display purposes. That is, the flat panel display 1 can be more compact. Furthermore, control of the OSD of the display panel 106 can only be effected through the touch panel 122 and the stylus pen 126, which can be detachable from the other parts of the system. This helps to avoid accidental operation of the OSD of the display panel 106. In an alternative embodiment, an integrated circuit (not shown) is integrated with the touch panel 122, for converting the recognized position information into signals for further processing. This configuration can reduce the physical size of the host 16 and/or the processing loading required of the host 16.

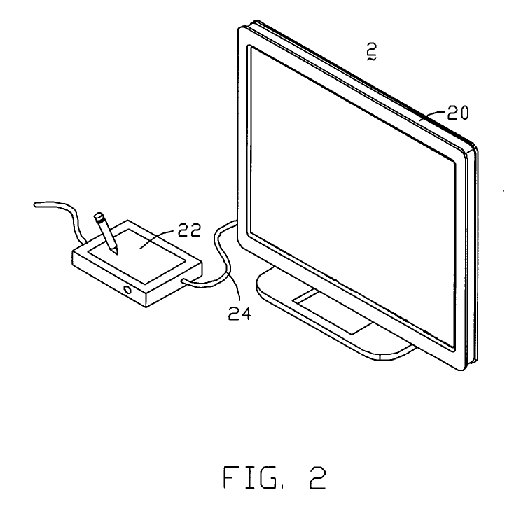

Referring to FIG. 2, a flat panel display 2 according to a second embodiment of the present invention is shown. The flat panel display 2 is similar to the flat panel display 1. However, the flat panel display 2 includes a display unit 20, a touch panel unit 22, and a power wire 24. One terminal (not labeled) of the power wire 24 is electrically connected with the touch panel unit 22, and the other terminal (not labeled) of the power wire 24 is electrically connected with the display unit 20. The display unit 20 can provide power for the touch panel unit 22 via the power wire 24. In an alternative embodiment, the other terminal of the power wire 24 can also be electrically connected with other devices that can provide suitable power for the touch panel unit 22. The flat panel display 2 has advantages similar to those of the flat panel display 1 described above.

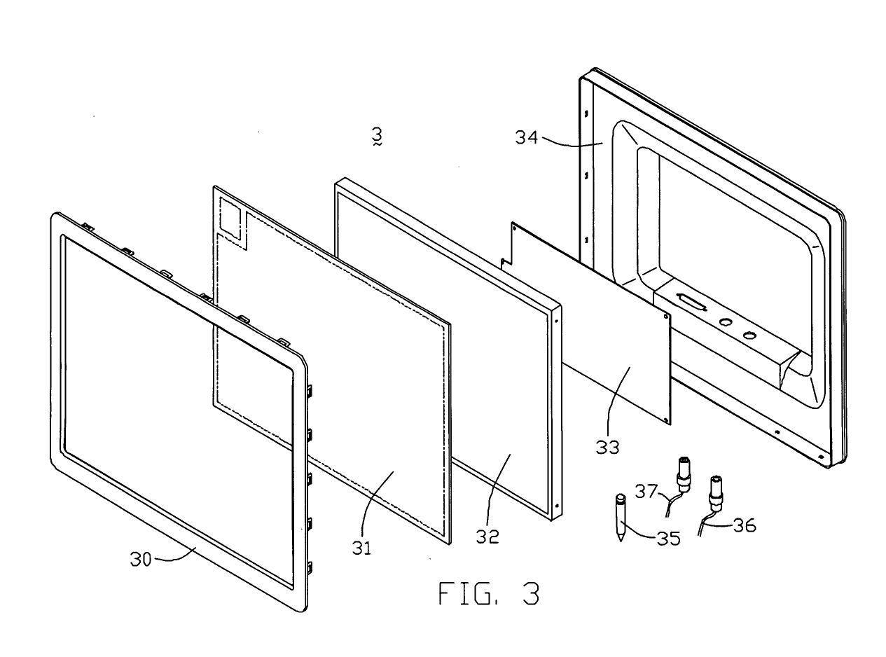

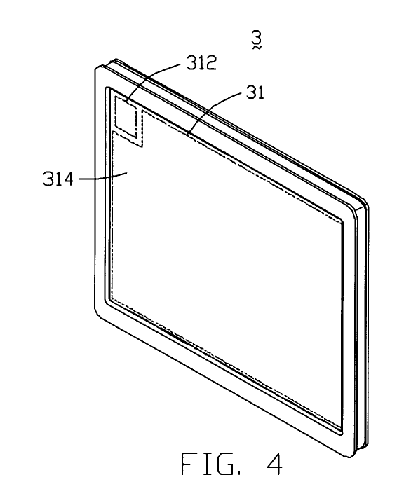

Referring to FIG. 3, a flat panel display 3 according to a third embodiment of the present invention is shown. The flat panel display 3 includes a front frame 30, a touch panel 31, a display panel 32, a printed circuit board (PCB) 33, a back cover 34, a stylus pen 35, a first connection wire 36, and a second connection wire 37. Referring also to FIG. 4, the front frame 30 and the back cover 34 cooperatively define a space (not labeled) for accommodating the touch panel 31, the display panel 32, and the printed circuit board 33. The touch panel 31 is attached to a front of the display panel 32. The back cover 34 defines two through holes (not labeled) acting as channels for terminals of the first connection wire 36 and the second connection wire 37 to respectively extend through.

The touch panel 31 includes an activation area 312, and a control area 314 adjacent to the activation area 312. In the illustrated embodiment, the activation area 312 is at a top left corner of the touch panel 31, and the control area 314 occupies other portions of the touch panel 31. An area occupied by the control area 314 is much larger than that occupied by the activation area 312.

In operation, the control area 314 can be activated according to the following steps. First, the activation area 314 of the touch panel 31 is contacted by a stylus pen (not shown) or by a user's fingertip, and a contact position is detected and recognized by the touch panel 31. Second, position information based on the recognized contact position is transmitted from a host (not shown) to the touch panel 31 via the first connection wire 36. Third, a program is run in the host for processing the position information, and a startup signal is generated and transmitted from the host to the touch panel 31 via the first connection wire 36. Thereby, the control area 314 is activated, and an OSD is provided on the display panel 32. In an alternative embodiment, an integrated circuit is integrated with the display panel 32 for converting the position information into signals for further processing. This configuration can reduce the physical size of the host and/or the processing loading required of the host 16.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A flat panel display comprising:
a display unit;
a touch panel unit configured for detecting contact by a stylus or a user's fingertip, recognizing a position of a point of the contact, and processing the contact as a corresponding instruction in relation to controlling an on screen display of the display unit; and
a host electrically connected with the touch panel unit via a connection route, the host configured for receiving position information based on the recognized contact position and converting the information to one or more corresponding control signals for controlling the on screen display of the display unit.

2. The flat panel display in claim 1, wherein the display unit comprises a display panel, a front frame, and a back cover, the front frame and the back cover cooperatively defining a space for accommodating the display panel.

3. The flat panel display in claim 2, wherein the front frame defines a window for allowing viewing of the display panel.

4. The flat panel display in claim 3, wherein the touch panel unit comprises a touch panel, and a shell receiving and protecting the touch panel, and the shell is a separate body from the display unit.

5. The flat panel display in claim 4, wherein the touch panel unit further comprises a stylus pen for contacting the touch panel unit for controlling the on screen display of the display panel.

6. The flat panel display in claim 2, wherein the on screen display shows parameters or states of brightness, contrast, color balance, sharpness, phase, a clock, or power saving mode of the display panel.

7. The flat panel display in claim 1, wherein the display unit comprises a display panel, the touch panel unit comprises a touch panel, and the touch panel is positioned in front of and adjacent to the display panel such that the display unit and the touch panel unit are combined together as a single body.

8. The flat panel display in claim 7, wherein the touch panel comprises an activation area, and a control area adjacent to the activation area.

9. The flat panel display in claim 8, wherein an area occupied by the control area is much larger than that occupied by the activation area.

10. A method of performing an on screen display, comprising steps of:
providing a display unit;
providing a touch panel unit configured for detecting contact by a stylus or a user's fingertip, recognizing a position of a point of the contact, and processing the contact as a corresponding instruction in relation to controlling the on screen display of the display unit; and
providing a host electrically connected to both the touch panel unit and the display unit, the host receiving position information based on the recognized contact position and converting the information to one or more corresponding control signals for controlling the on screen display of the display unit.
